(19) United States
(12) Patent Application Publication
(10) Pub. No.: US 2020/0311833 A1
(43) Pub. Date: Oct. 1, 2020

(54) GAS RECHARGE MANAGEMENT METHOD BASED ON COMPOUND INTERNET OF THINGS (IOT) AND IOT SYSTEM

(71) Applicant: Chengdu Qinchuan Technology Development Co., Ltd., Chengdu (CN)

(72) Inventor: Zehua Shao, Chengdu (CN)

(21) Appl. No.: 16/366,943

(22) Filed: Mar. 27, 2019

(51) Int. Cl. G06Q 50/06; G07F 15/06; G07F 15/00

(52) U.S. Cl. CPC G06Q 50/06; G01D 4/002; G07F 15/001; G07F 15/06

(57) ABSTRACT

The present invention provides a gas recharge management method based on a compound Internet of Things (IoT) and an IoT system, and relates to the field of an IoT. The gas recharge management method based on a compound Internet of Things (IoT) and an IoT system provided by the present invention can facilitate the user to recharge in time before the purchased gas is depleted, so as to effectively avoid the sudden stop of gas supply during use because the user does not recharge in time.

### TECHNICAL FIELD

The present invention relates to the field of the Internet of Things (IoT), and in particular to a gas recharge management method based on a compound IoT and an IoT system.

### BACKGROUND

Along with ever-changing development of an IoT technology, various instruments and meters, such as a gas meter, also enter the sector of an IoT. A traditional gas meter has been gradually replaced by an IoT intelligent gas meter.

During the use of gas, the sudden stop of gas supply during use often occurs because the user does not recharge in time, which affects the user's daily life.

### SUMMARY

In view of this, the present invention is to provide a gas recharge management method based on a compound IoT and an IoT system to facilitate users to recharge in time before the purchased gas is depleted, so as to avoid the sudden stop of gas supply during use because the user does not recharge in time.

To this end, the technical solutions adopted by the present invention are as follows:

According to a first aspect, the present invention provides a gas recharge management method based on a compound IoT, being applied to an IoT system; the IoT system comprises a plurality of object sub-platforms, a plurality of sensor network sub-platforms, a management platform, a plurality of service sub-platforms and a user platform; each of the object sub-platform comprises a gas meter; each of the sensor network sub-platform comprises an IoT intelligent gateway; the management platform comprises a gas company management server; and the method comprises:

sending, by the user platform, when a user recharges a gas meter via the user platform, the recharge information to at least one of the plurality of service sub-platforms;

sending, by a service sub-platform that receives the recharge information, the recharge information to the management platform; and

calculating, by the management platform, based on the gas remaining amount before the gas meter is recharged, the current gas price of the gas meter according to a predefined discount, and sending the recharge result to the gas meter via a sensor network sub-platform corresponding to the gas meter.

Further, the management platform presets a plurality of gas remaining sections, with each gas remaining section corresponding to a discount ratio, and the step of calculating, by the management platform, based on the gas remaining amount before the gas meter is recharged, the current gas price of the gas meter according to a predefined discount includes:

calculating, by the management platform, based on the gas remaining section corresponding to the gas remaining amount before the gas meter is recharged, the current gas price of the gas meter according to the discount ratio corresponding to the gas remaining section to get the gas remaining amount after recharging.

Further, the step of sending a recharge result to the gas meter via a sensor network sub-platform corresponding to the gas meter comprises:

sending, by the management platform, the gas remaining amount after the gas meter is recharged to the gas meter via a sensor network sub-platform corresponding to the gas meter.

Further, the method comprises:

updating, by the gas meter, the current gas remaining amount based on the recharge result.

Further, the method comprises:

sending, by the management platform, the recharge result to at least one of the plurality of service sub-platforms; and

sending, by a service sub-platform that receives the recharge result, the recharge result to the user platform.

According to a second aspect, the present invention also provides an IoT system; the IoT system comprises a plurality of object sub-platforms, a plurality of sensor network sub-platforms, a management platform, a plurality of service sub-platforms and a user platform;

when a user recharges a gas meter via the user platform, the user platform sends the recharge information to at least one of the plurality of service sub-platforms;

a service sub-platform that receives the recharge information, sends the recharge information to the management platform; and

the management platform, based on the gas remaining amount before the gas meter is recharged, calculates the current gas price of the gas meter according to a predefined discount, and sends the recharge result to the gas meter via a sensor network sub-platform corresponding to the gas meter.

Further, the management platform presets a plurality of gas remaining sections, with each gas remaining section corresponding to a discount ratio, and the step of calculating, by the management platform, based on the gas remaining amount before the gas meter is recharged, the current gas price of the gas meter according to a predefined discount includes:

calculating, by the management platform, based on the gas remaining section corresponding to the gas remaining amount before the gas meter is recharged, the current gas price of the gas meter according to the discount ratio corresponding to the gas remaining section to get the gas remaining amount after recharging.

Further, the step of sending a recharge result to the gas meter via a sensor network sub-platform corresponding to the gas meter comprises:

sending, by the management platform, the gas remaining amount after the gas meter is recharged to the gas meter via a sensor network sub-platform corresponding to the gas meter.

Further, the gas meter updates the current gas remaining amount based on the recharge result.

Further, the management platform sends the recharge result to at least one of the plurality of service sub-platforms;

a service sub-platform that receives the recharge result sends the recharge result to the user platform.

For the prior art, the gas recharge management method based on the compound Internet of Things (IoT) and the IoT System provided by the present invention have the following beneficial effects:

The present invention provides a gas recharge management method based on a compound Internet of Things (IoT) and an IoT System. The method includes: sending, by the user platform, when a user recharges the gas meter via the user platform, the recharge information to at least one of the plurality of service sub-platforms; sending, by a service sub-platform that receives the recharge information, the recharge information to the management platform; calculating, by the management platform, based on the gas remaining amount before the gas meter is recharged, the current gas price of the gas meter according to a predefined discount, and sending the recharge result to the gas meter through a sensor network sub-platform corresponding to the gas meter. The gas recharge management method based on the compound Internet of Things (IoT) and the IoT system provided by the present invention can facilitate the user to recharge in time before the purchased gas is depleted, so as to avoid the sudden stop of gas supply during use because the user does not recharge in time.

To make the above objectives, characteristics and advantages of the present invention more apparent and understandable, preferred embodiments are set forth hereinafter and are described below in detail in combination with accompanying drawings.

### BRIEF DESCRIPTION OF DRAWINGS

To make the objectives, technical solutions and advantages of the embodiments of the present invention clearer, a clear and complete description of the technical solutions in the present invention will be given below in combination with the accompanying drawings in the embodiments of the present invention. Apparently, the embodiments described below are a part, but not all, of the embodiments of the present invention. Generally, a component, described and illustrated in the accompanying drawings, in the embodiments of the present invention may be disposed and designed in various different configurations. Therefore, the following detailed description concerning the embodiments of the present invention and provided in the accompanying drawings is not intended to limit a claimed scope of the present invention, but merely represents selected embodiments of the present invention. All of the other embodiments, obtained by a person of ordinary skill in the art based on the embodiments of the present invention without any inventive efforts, fall into the protection scope of the present invention.

FIG. 1 is a compositional schematic diagram of an IoT system provided by an embodiment of the present invention.

FIG. 2 is a flowchart of a gas recharge management method based on a compound IoT provided by an embodiment of the present invention.

FIG. 3 is a schematic diagram of the corresponding relationship between the gas remaining sections and discount ratios.

FIG. 4 is a flowchart of another gas recharge management method based on a compound IoT provided by an embodiment of the present invention.

Numerals in the drawings: 100—IoT system; 10—object sub-platform; 20—sensor network sub-platform; 30—management platform; 40—service sub-platform; 50—user platform.

### DESCRIPTION OF EMBODIMENTS

A clear and complete description of the technical solutions in the present invention will be given below in combination with the accompanying drawings in the embodiments of the present invention. Apparently, the embodiments described below are a part, but not all, of the embodiments of the present invention. Generally, a component, described and illustrated in the accompanying drawings, in the embodiments of the present invention may be disposed and designed in various different configurations. Therefore, the following detailed description concerning the embodiments of the present invention and provided in the accompanying drawings is not intended to limit a claimed scope of the present invention, but merely represents selected embodiments of the present invention. All of the other embodiments, obtained by those skilled in the art based on the embodiments of the present invention without any inventive efforts, fall into the protection scope of the present invention.

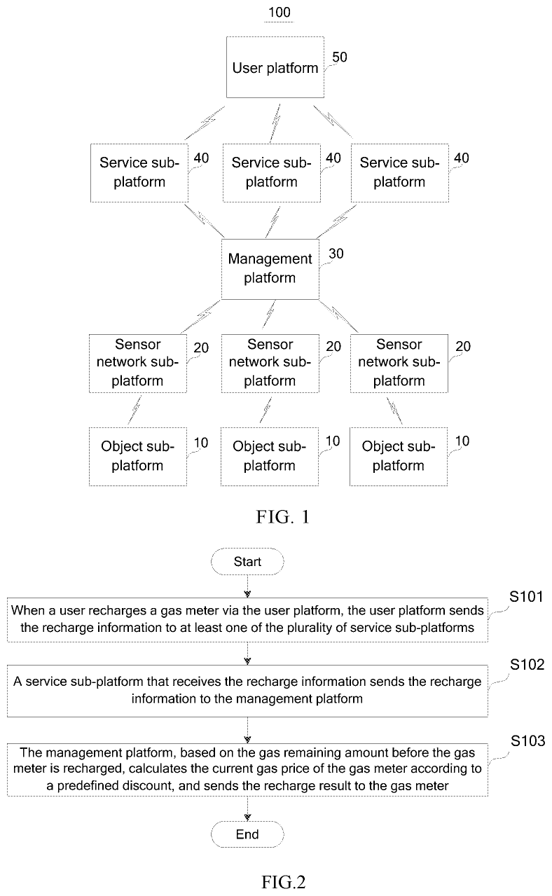

Referring to FIG. 1, a gas recharge management method based on a compound IoT provided by an embodiment of the present invention is applied to an IoT system 100. The IoT system includes a plurality of object sub-platforms 10, a plurality of sensor network sub-platforms 20, a management platform 30, a plurality of service sub-platforms 40, and a user platform 50. Herein, the plurality of object sub-platforms 10 may be communicatively connected with the management platform 30 via the plurality of sensor network sub-platforms 20, so as to send related data of the plurality of object sub-platforms 10 to the management platform 30, or receive control signals sent by the management platform 30, and the management platform 30 is communicatively connected with the plurality of service sub-platforms 40, and may push information to the plurality of service sub-platforms 40. In this embodiment of the present invention, each of the object sub-platform 10 comprises a gas meter; each of the sensor network sub-platform 20 comprises an IoT intelligent gateway; the management platform 30 comprises a gas company management server; the service sub-platforms 40 include a gas company operation server, a portal website server, or a government website server; the user platform 50 comprises a gas recharge terminal (such as a gas recharge terminal in a supermarket or a residence community). The gas recharge management method based on the compound Internet of Things (IoT) and the IoT system provided by embodiments of the present invention are used to, based on the gas remaining amount before the gas meter is recharged, calculate the current gas price according to the predefined discount when the user recharges the gas meter via the user platform, to facilitate the user to recharge in time before the purchased gas is depleted, so as to avoid the sudden stop of gas supply during use because the user does not recharge in time.

Referring to FIG. 2, a flowchart of a gas recharge management method based on a compound IoT is provided by an embodiment of the present invention, and the flow shown in FIG. 2 is described in detail below.

Step S101: When a user recharges a gas meter via the user platform 50, the user platform 50 sends the recharge information to at least one of the plurality of service sub-platforms 40.

In this embodiment of the present invention, each gas meter corresponds to a gas account, and gas accounts of a plurality of gas meters are managed by the same management platform 30. Each user can recharge the gas account of a gas meter at the user platform 50 terminal to purchase gas (each gas meter corresponds to a gas account, and that the user recharging the gas account is described hereinafter as recharging the gas meter for the ease of understanding).

After the user successfully recharges the gas meter at the user platform 50 terminal, the user platform 50 sends the recharge information of the user to at least one of the plurality of service sub-platforms 40. The recharge information includes the recharge amount.

Service sub-platforms 40 comprise a gas company operation server, a portal website server or a government website server. In this embodiment of the present invention, after the user successfully recharges the gas meter at the user platform 50 terminal, the user platform 50 sends the recharge information of the user to the gas company operation server. At the same time, it can also send the information to a portal website server or to a government website server.

Step S102: One of the service sub-platforms 40 that receives the recharge information sends the recharge information to the management platform 30.

After receiving the recharge information sent by the user platform 50, one of the plurality of service sub-platforms 40 sends the recharge information to the management platform 30. In this embodiment of the present invention, the service sub-platform 40 that sends the recharge information to the management platform 30 is a gas company operation server.

Step S103: The management platform 30, based on the gas remaining amount before the gas meter is recharged, calculates the current gas price of the gas meter according to a predefined discount, and sends the recharge result to the gas meter.

The management platform 30 presets a plurality of gas remaining sections, each of which corresponds to a discount ratio. During recharging, when the current gas remaining amount of the gas meter is in the plurality of gas remaining sections, the gas price can be discounted according to a certain proportion, and the proportion of discounts corresponding to different gas remaining section is also different. The management platform 30 can obtain the gas purchasing amount according to the recharge amount in the recharge information, current gas price, and corresponding discount ratio of the gas remaining amount before recharging, and then obtain the gas remaining amount after recharging according to the gas remaining amount before recharging and current gas purchasing amount.

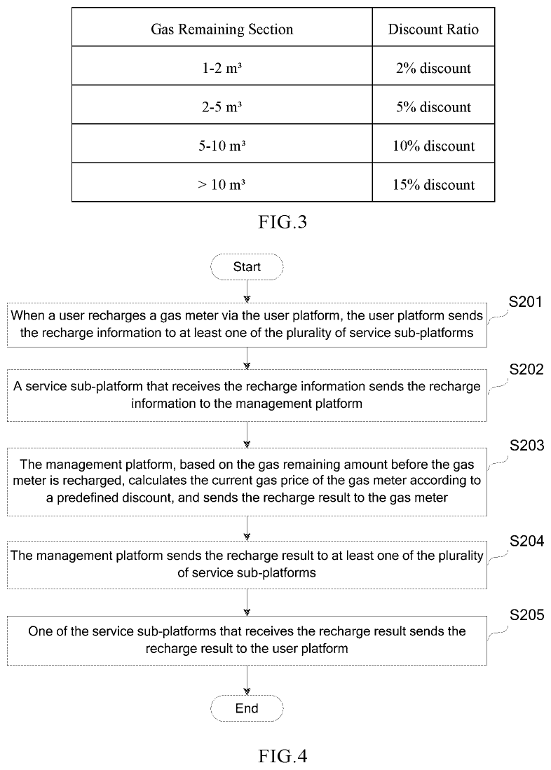

As shown in FIG. 3, it is the discount ratios corresponding to the gas remaining sections predefined by the management platform 30. When the current gas remaining amount of the gas meter is in the section of 1-2 m³, the current gas price is calculated with 2% discount. When the current gas remaining amount of the gas meter is in the section of 2-5 m³, the current gas price is calculated with 5% discount. When the current gas remaining amount of the gas meter is in the section of 5-10 m³, the current gas price is calculated with 10% discount. When the current gas remaining amount of the gas meter is in the section of more than 10 m³, the current gas price is calculated with 15% discount.

Certainly, the discount ratios corresponding to the remaining gas sections shown in FIG. 3 are only examples. In some other embodiments, the division of the remaining gas sections and the value of discount ratios can be adjusted based on the actual situation.

In this embodiment of the present invention, a gas meter is communicatively connected with the management platform 30 via a sensor network sub-platform 20. When the gas remaining amount after recharging is obtained, the management platform 30 sends the recharge result to the gas meter via the sensor network sub-platform 20 corresponding to the recharged gas meter, and the recharge result includes the gas remaining amount after recharging. The gas meter receives the recharge result sent by the management platform 30 and updates the current gas remaining amount.

Certainly, in some other embodiments, the recharge result may also include the remaining amount after recharging, that is, the management platform 30 may also send the remaining amount after recharging to the gas meter.

In conclusion, the gas recharge management method based on the compound Internet of Things (IoT) and the IoT system provided by the embodiments of the present invention can, when a user recharges, give a certain discount ratio to the gas price according to the gas remaining section for the gas remaining amount of the gas meter, which can bring the enthusiasm of the user to recharge in advance, promote the user to recharge in time before the gas is depleted, so as to avoid the sudden stop of gas supply during use because the user does not recharge in time.

Referring to FIG. 4, it is a flowchart of another gas recharge management method based on the compound IoT provided by a preferred embodiment of the present invention, and the flow shown in FIG. 4 is described in detail below.

Step S201: When a user recharges a gas meter via the user platform 50, the user platform 50 sends the recharge information to at least one of a plurality of service sub-platforms 40.

Step S202: One of the service sub-platforms 40 that receives the recharge information sends the recharge information to the management platform 30.

Step S203: The management platform 30, based on the gas remaining amount before the gas meter is recharged, calculates the current gas price of the gas meter according to a predefined discount, and sends the recharge result to the gas meter.

Step S204: The management platform 30 sends the recharge result to at least one of the plurality of service sub-platforms 40.

At the same time, the management platform 30 also sends the recharge result (including the gas remaining amount after recharging) to at least one of a plurality of service sub-platforms 40, which includes at least a gas company operation server.

In some other embodiments, the recharge result may also include the remaining amount of the gas meter after recharging.

Step S205: One of the service sub-platforms 40 that receives the recharge result sends the recharge result to the user platform 50.

After the management platform 30 sends the recharge result to at least one of the plurality of service sub-platforms 40, one of the service sub-platforms 40 that receives the recharge result sends the recharge result to the user platform 50.

In this embodiment of the present invention, the service sub-platform 40 that sends the recharge result to the user platform 50 is a gas company operation server.

In conclusion, the gas recharge management method based on the compound Internet of Things (IoT) and the IoT system provided by the embodiments of the present invention can, when a user recharges, give a certain discount ratio to the gas price according to the gas remaining section for the gas remaining amount of the gas meter, which can bring the enthusiasm of the user to recharge in advance, promote the user to recharge in time before the gas is depleted, so as to avoid the sudden stop of gas supply during use because the user does not recharge in time. At the same time, after the recharge is successful, the recharge result can be fed back to the user platform 50 in time, so that the user who recharges at the user platform 50 terminal can get the recharge result in time.

In several embodiments provided by the present application, it should be understood that the disclosed apparatus and method may also be implemented in other manners. The described apparatus embodiments are merely exemplary. For example, the flowcharts and block diagrams in the drawings illustrate the system architecture, function, and operation of possible implementations of apparatuses, methods, and computer program products according to various embodiments of the present invention. In this regard, each block in the flowcharts or block diagrams may represent a module, program segment, or portion of code, which includes one or more executable instructions for implementing the specified logical function(s). It should also be noted that in some alternative implementation manners, the functions noted in the block may occur out of the sequence noted in the drawings. For example, two continuous blocks, in fact, may be executed concurrently, or in a reverse order, which will depend upon the functions involved. It will also be noted that each block of the block diagrams and/or flowcharts, and combinations of blocks in the block diagrams and/or flowcharts, may be implemented by a special hardware-based IoT system that performs the specified functions or acts, or by using combinations of special hardware and computer instructions.

In addition, each module in the embodiments of the present invention may exist independently, and two or more modules may be integrated into an independent part.

When a function is implemented in the form of the software functional unit and sold or used as a separate product, the function may be stored in a computer readable storage medium. Based on such understanding, the technical solutions of the present invention or the part that makes contributions to the prior art or a part of the technical solutions may be substantially embodied in a form of a software product. The computer software product is stored in a storage medium, and includes several instructions to instruct a computer device (which may be a personal computer, server, network device, or the like) to execute all or some steps of the methods described in the embodiments of the present invention. The foregoing storage medium includes: various media capable of storing a program code, such as a disk, a mobile hard disk, a Read-Only Memory (ROM), a Random Access Memory (RAM), a magnetic disk or an optical disk. It should also be noted that, in the description, such relation terms as first and second are merely used for distinguishing one entity or operation from the other entity or operation, rather than requiring or hinting that these entities or operations have any practical relation or sequence. Moreover, the terms “comprise”, “include” or any other variant are intended to cover non-exclusive inclusion, so that the processes, methods, articles or devices including a series of factors not only include those factors, but also include other factors listed implicitly, or further include inherent factors of the processes, methods, articles or devices. In the absence of more limitations, the factors defined by the statement “include one . . . ” do not exclude other identical factors in the processes, methods, articles or devices including said factors.

The above are merely preferred embodiments of the present invention, and are not intended to limit the present invention. A person skilled in the art may make various modifications and changes to the present invention. Any modification, equivalent replacement, improvement and the like made within the spirit and principle of the present invention all shall be included in a scope of protection of the present invention. It should be noted that similar reference numerals and letters refer to similar items in the following drawings, and thus once an item is defined in one drawing, it does not need to be further defined and explained in the subsequent drawings.

The foregoing descriptions are merely specific implementation manners of the present invention, but are not intended to limit a scope of protection of the present invention. Any variation or replacement readily figured out by a person skilled in the art within the technical scope disclosed in the present invention shall fall within the scope of protection of the present invention. Therefore, the scope of protection of the present invention shall be subject to the scope of protection of the claims.

It should also be noted that, in the description, such relation terms as first and second are merely used for distinguishing one entity or operation from the other entity or operation, rather than requiring or hinting that these entities or operations have any practical relation or sequence. Moreover, the terms “comprise”, “include” or any other variant are intended to cover non-exclusive inclusion, so that the processes, methods, articles or devices including a series of factors not only include those factors, but also include other factors listed implicitly, or further include inherent factors of the processes, methods, articles or devices. In the absence of more limitations, the factors defined by the statement “include one . . . ” do not exclude other identical factors in the processes, methods, articles or devices including said factors.

What is claimed is:

1. A gas recharge management method based on a compound Internet of Things (IoT), wherein the method is applied to an IoT system; the IoT system comprises a plurality of object sub-platforms, a plurality of sensor network sub-platforms, a management platform, a plurality of service sub-platforms and a user platform; each of the object sub-platform comprises a gas meter; each of the sensor network sub-platform comprises an IoT intelligent gateway; the management platform comprises a gas company management server; and the method comprises:
sending, by the user platform, when a user recharges a gas meter via the user platform, the recharge information to at least one of the plurality of service sub-platforms;
sending, by a service sub-platform that receives the recharge information, the recharge information to the management platform; and
calculating, by the management platform, based on the gas remaining amount before the gas meter is recharged, the current gas price of the gas meter according to a predefined discount, and sending the recharge result to the gas meter via a sensor network sub-platform corresponding to the gas meter.

2. The gas recharge management method based on the compound IoT according to claim 1, wherein the management platform presets a plurality of gas remaining sections, with each gas remaining section corresponding to a discount ratio, and the step of calculating, by the management platform, based on the gas remaining amount before the gas meter is recharged, the current gas price of the gas meter according to a predefined discount comprises:
calculating, by the management platform, based on the gas remaining section corresponding to the gas remaining amount before the gas meter is recharged, the current gas price of the gas meter according to the discount ratio corresponding to the gas remaining section to get the gas remaining amount after recharging.

3. The gas recharge management method based on the compound IoT according to claim 2, wherein the step of sending a recharge result to the gas meter via a sensor network sub-platform corresponding to the gas meter comprises:
sending, by the management platform, the gas remaining amount after the gas meter is recharged to the gas meter via a sensor network sub-platform corresponding to the gas meter.

4. The gas recharge management method based on the compound IoT according to claim 2, wherein the method further comprises:
updating, by the gas meter, the current gas remaining amount based on the recharge result.

5. The gas recharge management method based on the compound IoT according to claim 1, wherein the method further comprises:
sending, by the management platform, the recharge result to at least one of the plurality of service sub-platforms; and
sending, by a service sub-platform that receives the recharge result, the recharge result to the user platform.

6. An IoT system, wherein the IoT system comprises a plurality of object sub-platforms, a plurality of sensor network sub-platforms, a management platform, a plurality of service sub-platforms and a user platform, wherein
when a user recharges a gas meter via the user platform, the user platform sends the recharge information to at least one of the plurality of service sub-platforms;
a service sub-platform that receives the recharge information sends the recharge information to the management platform; and
the management platform, based on the gas remaining amount before the gas meter is recharged, calculates the current gas price of the gas meter according to a predefined discount, and sends the recharge result to the gas meter via a sensor network sub-platform corresponding to the gas meter.

7. The IoT system according to claim 6, wherein the management platform presets a plurality of gas remaining sections, with each gas remaining section corresponding to a discount ratio, and the step of calculating, by the management platform, based on the gas remaining amount before the gas meter is recharged, the current gas price of the gas meter according to a predefined discount comprises:
calculating, by the management platform, based on the gas remaining section corresponding to the gas remaining amount before the gas meter is recharged, the current gas price of the gas meter according to the discount ratio corresponding to the gas remaining section to get the gas remaining amount after recharging.

8. The IoT system according to claim 7, wherein the step of sending a recharge result to the gas meter via a sensor network sub-platform corresponding to the gas meter comprises:
sending, by the management platform, the gas remaining amount after the gas meter is recharged to the gas meter via a sensor network sub-platform corresponding to the gas meter.

9. The IoT system according to claim 7, wherein the gas meter updates the current gas remaining amount based on the recharge result.

10. The IoT system according to claim 6, wherein the management platform further sends the recharge result to at least one of the plurality of service sub-platforms;
a service sub-platform that receives the recharge result sends the recharge result to the user platform.
